(19) United States
(12) Patent Application Publication
(10) Pub. No.: US 2006/0069610 A1
(43) Pub. Date: Mar. 30, 2006

(54) Browsing device and platform for management and distrubtion in server mode, in particular for the display of advertising links

(76) Inventor: Pascal Rossini, Clarens (CH)

Correspondence Address: Michael O. Sturm;Sturm & Fix, Suite 1213, 206 Sixth Ave, Des Moines, IA, 50309-4076, US

(21) Appl. No.: 10/536,068

(22) PCT Filed: Mar. 19, 2004
(86) PCT No.: PCT/IB04/00987

§ 371 Date: May 24, 2005

(51) Int. Cl. G06Q 30/00

(52) U.S. Cl. 705/14

(57) ABSTRACT

This invention relates to a device for browsing in a computer network such as the Internet, intended particularly for the display of advertising links.

This device includes a display panel (11) having at least one display zone (14) arranged to display one or more links that provide access to other pages accessible on the computer network. This display panel (11) is linked to a management site (21) including means (24) for managing display panels on the host sites. The management means (24) contain, in the management site, the data defining said display panels (11) on the host site (12). The configuration of the display panel does not include the computer code defining the host site (12), thus facilitating installation and the configuration of the display panel (11). This invention offers an application accessible to all individuals or companies wishing to use it to display and diffuse advertisements. Unlike the system of the invention, all prior art systems are closed, that is to say usable only by their author or owner.

### FIELD OF THE INVENTION

The present invention relates to making available an on-line application on a computer network such as the Internet, said application allowing the management of users and the diffusion of advertisements in the network. It also concerns a device for browsing in a computer network such as the Internet, which browser device in particular is intended for the display of advertising links called sponsored links thus allowing access to the sites of advertisers or sponsors. It can also be used to facilitate browsing on an Internet site or between sites.

The invention also concerns a management platform associated with this device, as well as a process for displaying these links, in particular advertising links.

### PRIOR ART

As it is well known, computer networks such as in particular the Internet allow access to sites organized into pages, hosted in servers and made available by so-called application service providers (ASP). Access to a determined site can be established by giving an URL (Uniform Resource Locator) type address or by clicking on a link from another site or from a search engine, for example. When access to a determined site, called a host site, has been made the user is generally provided with means to move within the network, either in the same site by displaying other pages or by connecting to other sites that have a link placed on the host site.

Firstly, it is to be noted that each site has its own specific configuration. When a site contains several different pages, possibly including links, there are essentially four means to move around the site, from one page to another or in the network from one page to another.

The first means consists in the use of hypertext-type links that appear on the site and allow access to another page of the site. These links are generally in a different colour to the text so as to highlight that they allow other functions than just text display. The same applies to hypertext links that connect to pages of sites other than the site to which a user is presently connected. In case hypertexts links are used to go from place to place, it is not possible to see the whole site, but only the visible links presently on the display. Therefore, it can be difficult to access certain pages when it is necessary to follow a chain of links to find the desired piece of information.

A second usual way to find one's bearings in a site consists in placing a menu on the site, using keywords to indicate the data available. This menu remains in the same place on all the pages of the site.

A third way to move around a site consists in including a search engine on this site that allows searches to be carried out on the site visited, starting from keywords.

A fourth way to move around a site consists in using a plan of the site, which uses keywords to describe the structure of this site in a way similar to a table of contents. In general, this allows the user to find his bearings. However, this plan is placed on a determined page and its contents are visible only when the given page is displayed. Each time a user wishes to move from one page to another using said means, it is necessary to return to the site plan.

At present there are numerous Internet sites proposing to site owners the addition of sponsored links. These links are placed on a host site and allow access to the site of an advertiser or sponsor for advertising purposes. For each netsurfer who accesses the sponsor's site through a host site, the sponsor pays a financial retribution which is to be distributed between the supplier of promotional services and the site owner who has agreed to integrate this type of link on his site. These services are well known and in particular are proposed by the companies Google and Ouverture. These services are known under the name “pay-per-click” when a payment is generated each time a site is accessed by a computer mouse click.

The addition of this type of promotional link imposes a certain number of constraints on the owner of the host site. In fact, it is necessary to reserve a specific place for such links, this place generally being chosen from among certain locations and certain predefined formats. Once the choice has been made, the owner of the host site must modify the computer code defining his own site in order to integrate a computer code defining the parameters of advertisements corresponding to the promotional links.

This method, which is the only one existing at present, has certain drawbacks, as it is necessary to define in the computer code of the host site the parameters defining the location for the display of the advertisements. On one hand, not all Internet site owners are proficient to modify their site code, while on the other hand each modification of the advertisement parameters involves the modification of the code. The choice of the location of the sponsored links or simply the colour of the display can only be modified with a change of code. In practice, when a change is desired, a request is made to the company that provides the sponsored link service then the company sends the new computer code to be introduced into the site. This consequently implies making tedious changes, even for minor modifications. Furthermore, it is laborious to carry out trials for different parameters, in order to test the different possible configurations to choose whichever is best adapted to the particular host site.

The addition of sponsored links on an already-existing site requires a modification of the site layout that involves consequential changes in the computer code defining the host site. This is tedious work that may discourage a site owner from integrating these types of links. Ideally, to be able to integrate sponsored links in an optimal way, the host site should be designed from the outset taking into account such links.

Another drawback of the known systems for displaying sponsored links originates from the manner in which the links are chosen. In practice, when the parameters, and in particular those setting the location and colour, have been defined, the advertising links displayed on a determined host site are proposed automatically. These links are determined according to an analysis of the contents of the host site, of its language and possibly other predefined parameters. A search is then carried out by means of a search engine among the sites of potential sponsors, that is to say the sites of owners having announced that they are prepared to pay a certain amount for each visit to their site originating from a host site. The aim of this search is to find one or more sites similar to a host site. This analogy is carried out in particular regarding the content and language of the sites. The links towards the sponsor sites are then integrated into the host site.

The result is that the host site inevitably integrates links towards the sites of its own competitors, since the subjects processed are analogous. To avoid this, the suppliers of these services propose means to make it possible to exclude specific competitor's sites by indicating their URL address. These means do not allow the personalized management of the links, that is to say a management of the links that responds to criteria specific to each owner of a host site.

### AIMS OF THE INVENTION

This invention proposes to mitigate the drawbacks of the browsing devices of the prior art by offering a flexible device that is simple to use and configure and that is applicable in particular to the display of advertising links or sponsored links. This device does not require the introduction of configuration parameters in the computer code of the host site, thus allowing easier installation and greater flexibility in its configuration and its method of use. As an auxiliary browsing element, it can remain at the disposition of the user continuously or on request. Furthermore, the device can be activated on-line immediately after registration.

As display element of sponsored links, it is possible to modify the display parameters in a simple and flexible way without modifying the computer code of the host site. It is also possible to install this device without having to modify the aesthetics of an existing site. Furthermore, the links appearing on the host site can be managed in an optimal way. For this, it is possible to define the links in such a way that they actually correspond to sites presenting an interest for the visitor of a host site, without creating a risk detrimental to the owner of the host site. This device allows so-called “pay-per-click” pay-access advertising services to be offered from more numerous host sites than previously, due to the ease of its installation and due to the fact that it does not require a change of site or changes regarding the code or its aesthetics. Due to the complexity of setting up prior art systems, it is not worthwhile for a host site owner receiving a limited number of visits to integrate these types of links on his site. In view of the fact that that this complex setting up has been eliminated, the integration of this service proves interesting even for host sites receiving few visits. As regards the advertisers or sponsors, the fact that a targeted public can access their site from a larger number of points makes the service particularly interesting.

This invention thus offers an application accessible to any individual or company desiring to use it in order to display and diffuse advertising. Unlike the system of the invention, all prior art systems are closed, that is to say usable only by their owner or person responsible for their use.

The invention also allows advertisers to make a bid, that is to say “to buy” by auction bids, the right to appear in a predominant position on a site or on a site that is visited very frequently. Furthermore, it allows the administration of accounts associated with the users of this invention.

The aims of the invention are achieved by a device for browsing in a computer network such as the Internet, this network comprising a plurality of sites, each site including at least one page defined by a computer code and intended to be visualized on a computer display, the browsing device including:
a display panel capable of being made visible on at least one page of a site called a “host site” when a user accesses this host site,
said display panel including at least one display zone arranged to display one or more links giving access to other pages accessible on said computer network,
said display panel being linked to a site called “management site”, this management site comprising management means of the display panels on the host sites, these management means containing, in the management site, the data defining said display panel on the host site.

The aims of the invention are also achieved by a management platform of a browsing device such as that defined above, intended for managing a plurality of browsing devices in a computer network such as the Internet, each browsing device being connected to a site called a host site made up of at least one page defined by a computer code accessible by said computer network, characterized in that this management site includes a management file associated to each browsing device, this file containing the data defining the appearance of said display panel on the host site.

These aims are also achieved by a process for operating a browsing device of a management site such as that defined above, characterized in that said management file is parameterized in the management site without using the computer code pertaining to the host site, this parameterization including a definition stage of form and/or location parameters of said display panel displayed on the host site.

The device of the invention allows browsing inside a site or between Internet sites to be simplified by proposing a displaceable display panel that can be hidden or made visible in a very simple way, and that integrates links. These links can be used to give access to specific data pages on the host site, to pages on other sites or can be sponsored links. The links can be defined manually by the owner of the host site or generated automatically according to defined criteria.

This device contains all elements needed for managing the users, that is to say in particular the owners of host sites and those of advertisement sites. It also permits the display of on-line advertising to be managed.

### BRIEF DESCRIPTION OF THE DRAWINGS

The invention will be better understood thanks to the following detailed description that refers to the accompanying drawings given as non-limitative examples, in which:

FIG. 1a shows the browsing device such as it would appear on the computer display of a host site when this device is shown;

FIG. 1b shows the device of FIG. 1a when it is partially closed;

FIG. 2 shows different elements interacting with the browsing device of the invention;

FIG. 3 is a diagram of a management site, also named management platform, according to the invention and its interaction with a computer network.

### EMBODIMENTS OF THE INVENTION

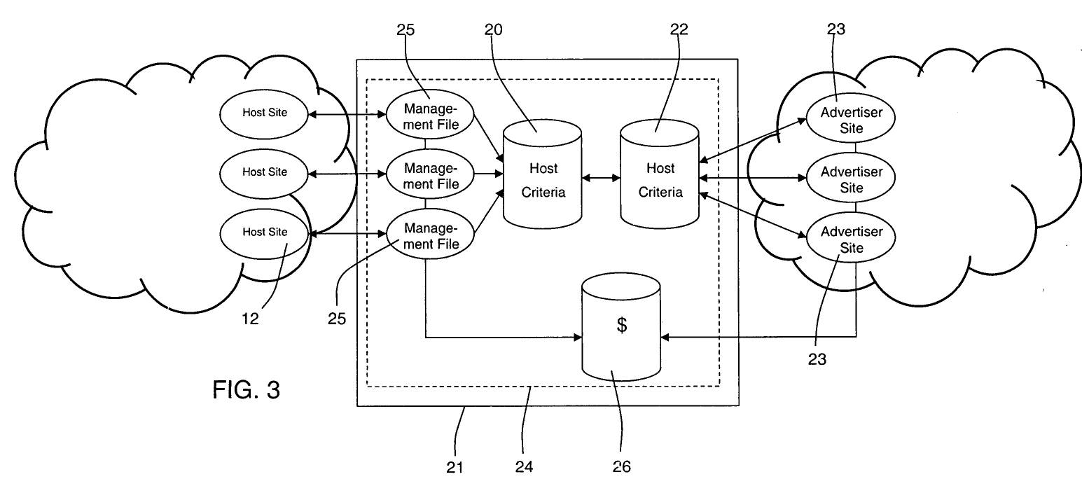

In essence, the elements forming the management platform shown together in FIGS. 2 and 3 are:
at least one management site 21 that is in charge of accounting and the diffusion of advertisements; this site allows control over host sites 12 and advertisers' sites 23;
management files inside the management site allowing users to construct a display panel 11 and to define target criteria;
advertiser sites allowing owners to make advertisements and diffuse them on targeted display panels of the host sites;
a final user site called host site 12 where the user defines selection criteria and downloads the display panel. Then the latter is installed on the Internet browser and delivers advertisements originating from advertisers sites.

The management platform also allows control over the display of links and payments, as well as invoicing.

The browser 10 according to the invention is not configured, as in the equivalent devices of the prior art, by a computer code integrated into the code of the host site. On the contrary, the configuration of the browser is carried out in a specific file, called a management file 25, managed by a management site, and containing the data necessary for the display of the links and the layout of the device.

The computer code of the host site 12 contains just one link that indicates the location of the management file 25. The latter contains the data necessary for the configuration of the browser 10. This file can be accessed by the owner of the host site 12, and modified at his convenience, without the owner of the management site having to intercede. In this way, different configurations can be tested very easily, allowing great flexibility for the user.

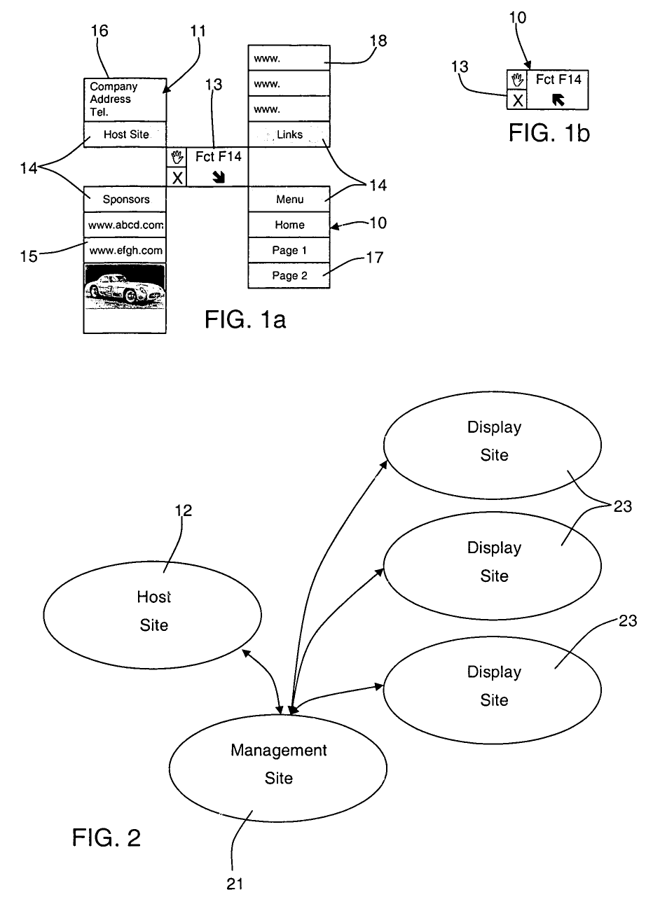

With reference to FIGS. 1a and 1b, the browser 10, according to the invention, notably includes a display panel 11 that can be made visible from a host site 12, on a computer display. According to the invention, the device is provided to allow the display of this panel according to several predefined formats and in particular according to the five formats described below. The first format is conventional and is known as a banner. It consists of a horizontal band generally placed at the top of a page of a site.

The second format also corresponds to a band, which is vertical and generally placed on the left or the right of the page. These bands have dimensions that, without being normalized, are relatively standard so that the site creators can provide a (corresponding) reserved zone during the design of an Internet site.

The third format is a vertical band, placed on the left of the page, in a zone usually reserved for the display of general data such as the history of the last sites visited or the user's favourite sites. This zone is known under the term “side bar”.

The fourth format is called a toolbar, which is a horizontal band that is displayed at the top of the screen, near the menu bar. According to one variant, the display panel can be displayed in the form of a tool bar in electronic messages.

Although these four display formats correspond to known formats, the display panel used is new, due to the fact that technically it is not executed in a conventional way, as is explained in detail below. These formats are proposed so that the browsing device according to the invention is compatible with the existing sites designed to integrate advertising banners and to offer the largest possible choice to users. There are also other formats, in particular rectangles inserted onto the screen, for example in the middle of the screen.

In general, regardless of the format used, the display panel can be personalized by the user. For this, the user can indicate his areas of interest; and advertising links are displayed in reiation to these areas of interest. The display panel can also be personalized by a company wishing to carry out an advertising campaign. Functions can also be added, such as in particular a pop-up advertisement blocking tool.

When the final user has defined his choice criteria or areas of interest, he downloads the display panel which is then able to display advertising links.

The fifth format described is that which is disclosed in FIG. 1a. In this example, which constitutes the preferred embodiment of the invention, the display panel 11 includes five zones. The first zone is a function control zone 13, displaying the indications for the management of the panel itself and for access to particular functions. These indications can, for example, concern shifting, opening, closing, display or elimination of the panel 11. Closure of the panel 11 is understood to mean elimination of the display of the zones forming this panel, with the exception of the function control zone. Opening is understood to mean the display of all the zones 13, 14 of the display panel. Elimination corresponds to the complete removal of the panel 11, including the function control zone 13. Deployment corresponds to the visualization of at least one part of the panel 11, that is to say at least the function control zone 13 and, optionally, the other zones, namely said display zones 14.

The panel 11 according to the invention is embodied in the form of software, preferably written in a language known under the acronym “dhtml” (dynamic hypertext markup language), that offers flexibility adapted to these types of applications.

In the embodiment disclosed in FIG. 1a, the panel includes four rectangular display zones 14, arranged around the function control zone 13. This control zone 13 is rectangular and the display zones open in the four corners of the control zone. These display zones allow different types of elements to be made visible. Among these, there are in particular advertising links, or sponsored links, that is to say links that allow a netsurfer to access an advertising site from a host site. These links are represented by reference 15 in FIG. 1a. The provision and the use of such links are explained in detail below.

According to a preferred embodiment, at least one display zone 14 is reserved for the display of advertising links, while the other zones are left at the disposal of the user. Among the types of display, there may be data without a link, for example the address or telephone number of the owner of the host site or of the company, as represented by reference 16 in FIG. 1a. It is also possible to display photography or an access map or any other element of this type. Clicking on this type of element has no effect.

Another type of element can include a link towards another page on the host site, as indicated by reference 17. This link can be indicated in the form of a URL address, a text and/or an image. For example, it is possible to display an image representing an access map connected to a page of the site including the same access map on a larger scale. It is also possible to add text or an image to a multimedia file.

Another element can include a link towards a page of another Internet site. As previously, the link can be executed in the form of a URL address, a text and/or an image. This is illustrated by reference 18.

According to a first embodiment, the links are defined by the owner of the host site, using a configuration assistance menu which is found in the management site 21, by introducing first the element (text/image) that the user wishes to display in a corresponding zone of the display panel, then by connecting this element to a URL address, if necessary.

According to a second embodiment, the links are automatically generated in the following way. When the owner of a host site 12 wishes to place sponsored links 15 on his site, he defines the types of links that he wants to appear by means of keywords and/or categories. These are stored in a database 20 of a management site 21, as represented in FIG. 3. Similarly, by means of a second configuration assistance menu intended for sponsors, an advertiser who wants links towards his site to appear on a host site defines the type of host sites on which he wishes his link to be seen by means of keywords or categories. These elements are also stored in a database 22 of the management site 21. An automatic search for links is carried out on the basis of these categories and/or these keywords, by searching for a similarity between the host sites and the advertisers.

In this embodiment, it is possible to define a maximum number of displayed links. As an example, a maximum N can be displayed, for example ten links in one zone of the panel. These N links can be the most pertinent N links, that is to say those for which the criteria defined by the host site and the advertisers sites are the most similar. It is also possible to display N links determined at random or according to a rule established among all the advertiser sites that respond to the criteria of the host site.

According to a particular embodiment of the invention, the elements displayed in each zone of the display panel are of a same type. For example, one of the zones 16 contains only data without a link. Another zone 17 of the array contains only links towards other pages of the host site. A third zone 18 contains only links towards the pages of other sites and the fourth zone 15 contains sponsored links.

It is possible for the display of certain zones to be optional while, for others the display is obligatory. In particular, the display of a zone containing sponsored links 15 would be obligatory, while the use of the other zones is left under the control of the owner of the host site.

The function control zone 13 can contain icons or text that render intelligible the different functions available. For example, by placing a pointer such as a computer mouse on a specific icon in the functional zone, having for example the form of a hand, and by moving this pointer, it is possible to displace the display panel 11, which allows access to the entire contents of a page of the site without having to close the display panel. It is also possible to associate an action on a computer to a function of the display panel. As an example, the pressing of a function key designated by “Fct”, together with the pressing of a mouse button can create one or more actions such as opening or closing, display or elimination of the display panel 11; these actions can be different as a function of the present state of the panel.

FIG. 2 describes different elements that are linked to the above-described browser 10. As previously indicated, the display panel 11 is made visible from a host site 12 and gives access to one or several display sites 23 by means of links that may be sponsored. FIG. 2 shows one host site 12, from which a display panel 11 can be displayed as represented in FIGS. 1a and 1b, as well as several display sites 23 accessible through the display panel. This Figure also represents a management site 21 whose function is explained below, also with reference to FIG. 3.

This management site 21 contains management means 24 including the data necessary for the definition of the display panel. More concretely, the management site 21 includes, for each host site 12, formal data and basic data.

The formal data relates in particular to the size, location, colours and the form of the display panel 11. It can also relate to the number of zones displayed or any other data that allows the definition of the general aspect of the display panel 11.

The basic data relates to the data necessary for the working of the display panel 11, in particular the URL addresses of the links to appear on the panel 11. It also relates to the keywords and the criteria that have been defined by the owner of the host site and that are stored in the database 20 for the criteria of the host sites 12.

This information is contained in a computer file called a management file 25 and connected to the management centre 21. A link towards this file 25 must be placed in the computer code of the host site 12. It should be noted that this link is only formed by the file address and that no other element must be modified in the computer code of the host site 12. This means, in particular, that the computer code of the host site 12 does not contain any information relating to the aforementioned formal data, unlike the sites existing at present.

The display panel 11 of the device of the invention is configured according to the requirements of the owner of the host site 12 and is configured by this owner, starting from his site, by accessing the management file 25 containing all the data required. It is to be noted that a configuration assistance menu can be provided to assist defining not only the formal aspects of the display panel 11, but also the functional aspects. This assistance menu can, for example, propose different formats for the display panel 11 that are predefined and/or to be chosen by the user. The assistance menu also allows the introduction of keywords in free text form and/or the designation of predefined categories.

Access to the file 25 of the management site 21 related to a determined host site 12 is carried out by providing an identification code connected to this host site 12, in such a way as to guarantee that the person seeking to access this file 25 is in possession of the necessary rights. This identification can be carried out in a conventional way by the introduction of a username and a password, although other means such as, in particular, cryptographic processes can be used. When the management centre 21 has determined that a person has the necessary rights to modify the contents of the management file 25, the latter is made accessible to this person, in such a way as to authorize a certain number of modifications.

This procedure is particularly advantageous, due to the fact that installation, configuration and modifications are extremely simple to carry out and are implemented immediately. Therefore, it is possible, for example, to test different page layouts of the display panel 11, by varying the number of zones 14 displayed, their size, colours, etc., until a suitable page layout is found. Similarly, at any moment it is possible to eliminate a link or add another or to correct links that are no longer valid without having to wait for an authorization of the manager of the management sites 21. If the sponsored links 15 appearing on the host site 12 are not deemed suitable for its owner, it is also very simple to prohibit the display of a determined link by indicating its URL address in the management file 25 and by specifying that this link should not be used. It is also possible to change the keywords or the categories used, that results in modifying the automatically-generated links.

As previously indicated, the management centre 21 contains another database 22, attached to advertisers or sponsors. This database 22 contains all the data related to these advertisers, in particular the categories and/or the keywords defining their site or the host sites 12 on which they want to appear. As an example, an advertiser marketing top-of-the-range cars intended for certain determined socio-professional categories could register under the keywords or categories relating to this kind of clientele, rather than in the category “Car”.

The advertiser database 22 also contains a certain number of criteria necessary for the management of the financial aspects of the links. In particular, this database 22 can contain a total amount corresponding to the maximum amount that the advertiser is prepared to invest for a given campaign, as well as an amount to be paid for access to its advertisements from a host site, called cost-per-click. Hence, each time a netsurfer accesses a sponsor's site through a host site, the sponsor pays an amount corresponding to the cost-per-click, until the total amount is reached. At this moment, the advertiser will be requested to pay into his account or the link will be withdrawn from the host site 12. It should be noted that the cost-per-click can be defined statically or dynamically and variably according to certain parameters such as the number of genuine visits per day, etc. In practice, the cost-per-click can be defined according to the number of categories and/or keywords introduced by the sponsor. The higher the number of categories, the more targeted are the advertisements and the higher the cost-per-click. Other financial approaches can also be provided. For example, it is possible to define not only a cost-per-click but also a cost for the duration of visits to the sponsor's site, on the basis that the longer the visit to the site, the more interested the visitor will be. Of course, a combination of the two approaches is possible, by combining a flat rate through a cost-per-click and a variable cost according to duration.

The management centre 21 includes a financial management database 26. This base registers the host sites 12 from which the sponsor sites 23 have been visited, the sponsor sites 23 that have been visited in relation to the host site 12 that generated these visits, as well as invoicing parameters. These parameters are those previously mentioned, namely the cost-per-click and/or the visit duration, as well as all parameters that must be taken into account to establish a distribution of the amounts involved in these operations.

This invention is particularly advantageous over prior art devices, since it combines the advantages of different existing browsing systems, without presenting the drawbacks. In particular, the device does not require the introduction of the configuration parameters into the computer code of the host site, which allows simpler installation and greater flexibility in its configuration and method for use. As an auxiliary aid element to browsing it can remain available to the user either continuously or on request. The display panel 11 allows browsing between sites or within one site. It is very user-friendly and effective, without implying an important and irreversible loss of the space available to display useful data. Furthermore, it allows the management of sponsored links in a simple, flexible and targeted way both for the owner of a host site as well as for the owner of a sponsor site.

1. Device for browsing in a computer network such as the Internet, this network comprising a plurality of sites, each site comprising at least one page defined by a computer code and intended to be visualized on a computer display, the browser (10) including:
a display panel (11) capable of being made visible on at least one page of a site called a host site (12) when a user accesses this host site,
said display panel (11) including at least one display zone (14) arranged to display one or several links giving access to other pages accessible on said computer network,
said display panel (11) being linked to a site called “management site” (21), this management site (21) including means (24) for the management of display panels on host sites, these management means containing, in the management site, data that defines said display panel (11) on the host site (12):

2. Browsing device according to claim 1, characterized in that said display panel (11) includes several display zones (14).

3. Browsing device according to claim 1 or 2, characterized in that the display panel (11) also includes a function control zone (13).

4. Browsing device according to claims 2 or 3, characterized in that said display zone(s) (14) are structured to display at least one of the following types of links: sponsored link (15); link (18) towards a page on another site; link (17) towards another page on the host site.

5. Browsing device according to any previous claim, characterized in that said display zone(s) (14) include images and/or text in relation to the links.

6. Browsing device according to any previous claim, characterized in that said display panel (11) is made visible on said host site (12) according to one of the following methods: superposition on said page of the host site, integrated into a given location on said page, or on a panel common to several pages of this host site.

7. Browsing device according to any previous claim, characterized in that at least part of said links is managed by the management site (21).

8. Browsing device according to any previous claim, characterized in that the computer code of the host site (12) contains an address corresponding to a management file (25) of the management site (21).

9. Browsing device according to claim 8, characterized in that the management means (24) of the management site (21) include means to count the number of times one of said links of each host site (12) is used to access a sponsor site (23) and/or the visit duration of the sponsor site, as well as the number of times that each sponsor site is visited from a host site and/or the visit duration.

10. Browsing device according to any previous claim, characterized in that said display panel (11) is movable by the user on the screen displaying the host site (12).

11. Browsing device according to claim 3, characterized in that said display panel (11) is made up of a function control zone (13), this zone having a rectangular form, and four rectangular display zones (14) that can be opened in the corners of the control zone (13).

12. Browsing device according to any previous claim, characterized in that at least one of the display zones (14) is reserved for the display of sponsored links (15).

13. Management platform of a browsing device according to any previous claim, intended for managing a plurality of browsing devices in a computer network such as the Internet, each browsing device being connected to a site called a host site (12) made up of at least one page defined by a computer code accessible by said computer network, characterized in that this management site (21) includes a management file (25) associated to each browsing device (10), this file containing data defining the appearance of said display panel (11) on the host site.

14. Management platform according to claim 13, characterized in that it includes management means (24) organized to count the number and/or duration of visits to certain sites called sponsor sites (23) made from each host site (12).

15. Management platform according to claim 13 or 14, characterized in that it includes first storage means (20) for storing keywords and/or categories associated to each host site (12) and second storage means (22) for storing keywords and/or of categories associated to each sponsor site (23).

16. Management platform according to claim 15, characterized in that it includes means to establish a correspondence between the keywords and/or the categories of each host site with the keywords and/or the categories of at least one sponsor site (23), and means to send an image and/or text connected to said sponsor site for which a correspondence has been established, this image and/or text being displayed on a display zone (14) of the display panel (11) of said host site (12).

17. Process of activating a browsing device (10) of a management platform according to claim 13, characterized in that said management file (25) in the management site is parameterized without using the computer code pertaining to the host site (12), this parameterization including a definition stage of form and/or location parameters of said display panel displayed on the host site.

18. Process according to claim 17, characterized in that it also includes the steps of:
determining at least one address of a sponsor site (23) to connect through a sponsored link (15) to said host site (12); and
displaying on the display panel (11) a visual element associated to said sponsored link (15).

19. Link display process according to claim 17 or 18, characterized in that the parameterization step also includes on the one hand a step for defining keywords and/or categories pertaining to said host site (12) and on the other hand a step for defining keywords and/or categories pertaining to said sponsor sites (23).

20. Link display process according to claim 18 or 19, characterized in that the step of determining at least one address is carried out by a search for correspondence between keywords and/or categories of sponsor sites (23) with keywords and/or categories of each host site (12).

21. Link display process according to claim 20, characterized in that the search for correspondence between keywords and/or categories of sites is carried out automatically, in the management site (21).

22. Link display process according to claim 21, characterized in that it includes a step of determining links to be maintained or to be eliminated from the links found by the correspondence search.

23. Link display process according to any of claims 17 to 22, characterized in that it includes a step of accounting for the number of times one of said sponsor sites (23) is accessed from a host site (12) and/or the visit duration.
